(19) United States
(12) Patent Application Publication
(10) Pub. No.: US 2018/0357971 A1
(43) Pub. Date: Dec. 13, 2018

(54) GATE DRIVING METHOD, GATE DRIVING CIRCUIT AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventor: Lei LIU, Beijing (CN)

(73) Assignees: BOE TECHNOLOGY GROUP CO., LTD., Chongqing (CN); BEIJING BOE DISPLAY TECHNOLOGY CO., LTD., Beijing (CN)

(21) Appl. No.: 15/514,662

(22) PCT Filed: May 11, 2016
(86) PCT No.: PCT/CN2016/081690

§ 371 Date: Mar. 27, 2017

(30) Foreign Application Priority Data
Mar. 2, 2016 (CN) 201610118363.4

(51) Int. Cl. G09G 3/36

(52) U.S. Cl. CPC G09G 3/3677; G09G 2310/08; G09G 2310/0221

(57) ABSTRACT

It is provided a gate driving method, a gate driving circuit and a display device. The gate driving method for a display panel includes applying a respective gate driving voltage to each gate line according to a distance between the gate line and a gate driving circuit in the display panel. A display region of the display panel is divided into a plurality of gate line regions, and each of the gate line regions is provided with at least one gate line and corresponds to the respective gate driving voltage. The gate driving voltages applied to the gate lines are in an ascending order from a gate line in a gate line region closest to the gate driving circuit to a gate line in a gate line region farthest from the gate driving circuit.

### CROSS REFERENCE OF RELATED APPLICATION

The present application claims a priority of Chinese Patent Application No. 201610118363.4 filed on Mar. 2, 2016, the disclosure of which is incorporated herein by reference in its entirety.

### TECHNICAL FIELD

The present disclosure relates to a technical field of displaying, and in particular to a pixel driving method, a pixel driving circuit and a display apparatus.

### BACKGROUND

In recent years, display sizes of display panels are increasing and display quality of the display panels are improved to satisfy customers' requirements. Due to the increasing display sizes of the display panels, a gate line signal has to be transmitted through a longer path. As a result, a loss of the gate line signal may easily occur, which may adversely affect a charging uniformity of a large-scale liquid crystal display (LCD) panel.

### SUMMARY

An object of the present disclosure is to provide a solution to prevent a loss of a gate line signal from occurring in a large scale LCD panel, so as to improve a charging uniformity of the large scale LCD panel.

In one aspect, the present disclosure provides in some embodiments a gate driving method for a display panel, including: applying a respective gate driving voltage to each gate line according to a distance between the gate line and a gate driving circuit in the display panel. A display region of the display panel is divided into a plurality of gate line regions, each of the gate line regions is provided with at least one gate line and corresponds to the respective gate driving voltage, and the gate driving voltages applied to the gate lines are in an ascending order from a gate line in a gate line region closest to the gate driving circuit to a gate line in a gate line region farthest from the gate driving circuit.

Optionally, applying the respective gate driving voltage to each gate line according to the distance between the gate line and the gate driving circuit in the display panel includes: determining a first gate line region where a first gate line to which the respective gate driving voltage is to be applied currently is arranged; determining a first gate driving voltage corresponding to the first gate line region according to a first correspondence between gate line regions and gate driving voltages; applying the first gate driving voltage to the first gate line.

Optionally, determining the first gate line region where the first gate line to which the respective gate driving voltage is to be applied currently is arranged includes: obtaining a row number of the first gate line; determining a gate line region corresponding to the row number of the first gate line to be the first gate line region according to a second correspondence between row numbers of the gate lines and gate line regions.

Optionally, obtaining the row number of the first gate line includes: counting timing signals outputted by a timing controller in the display panel to obtain a counting result; determining the row number of the first gate line according to the counting result.

Optionally, prior to count the timing signals outputted by the timing controller in the display panel, the method further includes: transmitting a reset signal to a counter to zero the counter before each period for applying the gate driving voltages for the display panel, and starting the counter to count the number of the timing signals.

Optionally, the timing signals are clock (CLK) signals, output enable (OE) signals or touch panel (TP) signals.

Optionally, the number of gate lines arranged in each gate line region is same.

Optionally, an incremental voltage for each two adjacent gate line regions is same and greater than 0, and the incremental voltage is obtained by subtracting the gate driving voltage corresponding to one of the two adjacent gate line regions closer to the gate driving circuit from the gate driving voltage corresponding to the other one of the two adjacent gate line regions farther away from the gate driving circuit.

In another aspect, the present disclosure provides in some embodiments a gate driving circuit for a display panel, including: a driving module configured to apply a respective gate driving voltage to each gate line according to a distance between the gate line and a gate driving circuit in the display panel, wherein a display region of the display panel is divided into a plurality of gate line regions, each of the gate line regions is provided with at least one gate line and corresponds to the respective gate driving voltage, and the gate driving voltages applied to the gate lines are in an ascending order from a gate line in a gate line region closest to the gate driving circuit to a gate line in a gate line region farthest from the gate driving circuit.

Optionally, the driving module includes: a first determination module configured to determine a first gate line region where a first gate line to which the respective gate driving voltage is to be applied currently is arranged; a second determination module configured to determine a first gate driving voltage corresponding to the first gate line region according to a first correspondence between gate line regions and gate driving voltages; an input module configured to apply the first gate driving voltage to the first gate line.

Optionally, the first determination module includes: an obtaining unit configured to obtain a row number of the first gate line; a determination unit configured to determine a gate line region corresponding to the row number of the first gate line to be the first gate line region according to a second correspondence between row numbers of the gate lines and gate line regions.

Optionally, the obtaining unit is further configured to count timing signals outputted by a timing controller in the display panel to obtain a counting result; and determine the row number of the first gate line according to the counting result.

Optionally, before counting the timing signals outputted by the timing controller in the display panel, the obtaining unit is further configured to transmit a reset signal to a counter to zero the counter before each period for applying the gate driving voltages for the display panel, and then start the counter to count the number of the timing signals.

Optionally, the timing signals are CLK signals, OE signals or TP signals.

Optionally, the number of gate lines arranged in each gate line region is same.

Optionally, an incremental voltage for each two adjacent gate line regions is same and greater than 0, and the incremental voltage is obtained by subtracting the gate driving voltage corresponding to one of the two adjacent gate line regions closer to the gate driving circuit from the gate driving voltage corresponding to the other one of the two adjacent gate line regions farther away from the gate driving circuit.

In yet another aspect, the present disclosure provides in some embodiments a display device including the above gate driving circuit.

As compared with the related art, the present disclosure provides the gate driving method, the gate driving circuit and the display panel where a larger gate driving voltage is applied to a gate line farther away from the gate driving circuit and a smaller gate driving voltage is applied to a gate line closer to the gate driving circuit in the display panel. As a result, it may prevent the loss of the gate line signal from occurring in the large scale LCD panel, so as to improve a charging uniformity of the large scale LCD panel.

### BRIEF DESCRIPTION OF THE DRAWINGS

FIG. 1 is a schematic view showing a gate electrode driving method according to an embodiment of the present disclosure;

FIG. 2 is a schematic view for driving gate electrodes according to an embodiment of the present disclosure;

FIG. 3 is a schematic view showing a computation procedure for a Power Management Integrated Circuit (PMIC) according to an embodiment of the present disclosure;

FIG. 4 is a schematic view showing a gate driving circuit according to an embodiment of the present disclosure.

### DETAILED DESCRIPTION

In the following, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

The present disclosure provides in some embodiments a gate driving method for applying gate driving voltages for a display panel. FIG. 1 is a schematic view showing a gate electrode driving method according to an embodiment of the present disclosure. As shown in FIG. 1, the method includes a step S1 of: applying a respective gate driving voltage to each gate line according to a distance between the gate line and a gate driving circuit in the display panel, wherein display region of the display panel is divided into a plurality of gate line regions, each of the gate line regions is provided with at least one gate line and corresponds to the respective gate driving voltage, and the gate driving voltages applied to the gate lines are in an ascending order from a gate line in a gate line region closest to the gate driving circuit to a gate line in a gate line region farthest from the gate driving circuit.

Thus, the gate driving voltages may be applied to the gate lines in a manner that the gate driving voltages are in an ascending order from a gate line in a gate line region closest to the gate driving circuit to a gate line in a gate line region farthest from the gate driving circuit. In other words, the display panel is divided into a plurality of gate line regions, and each of the gate line regions is provided with a gate driving voltage. Thus, for each gate line arranged in each gate line region, a gate driving voltage provided for the gate line region where the gate line is arranged may be applied to the gate line.

As compared with the related art where an identical driving voltage is applied to each of the gate lines in the LCD panel, in the present disclosure, it is able to prevent a loss of a gate line signal due to a large distance between the gate line and the gate driving circuit from occurring in a large scale LCD panel, so as to improve a charging uniformity of the large scale LCD panel.

For example, during a process for applying a respective gate driving voltage to each of the gate lines, the following steps may be executed according to a distance between the gate line and the gate driving circuit.

S101: determining a first gate line region where a first gate line to which the respective gate driving voltage is to be applied currently is arranged.

Each of the gate line regions may include one or more gate lines, and each of the gate line regions corresponds to a respective gate driving voltage. Thus, a gate driving voltage to be applied to a gate line may be determined as long as a gate line region where the gate line is arranged is determined.

Naturally, the number of the gate lines in each gate line region may be identical or different.

In actual implementation, the number of the gate lines in each gate line region is not particularly defined. Generally, dozens of gate lines may be arranged in one gate line region. Alternatively, hundreds of gate lines, several gate lines or even one gate line may be arranged in one gate line region. From the point of view of driving efficiency, it is time consuming for providing a respective gate driving voltage for each of the gate lines by adding an incremental voltage for the gate line that is farther away from the gate driving circuit than an adjacent gate line. However, a charging uniformity of the display panel may be maintained.

For example, an incremental voltage for each two adjacent gate line regions is same and greater than 0, and the incremental voltage is obtained by subtracting the gate driving voltage corresponding to one of the two adjacent gate line regions closer to the gate driving circuit from the gate driving voltage corresponding to the other one of the two adjacent gate line regions farther away from the gate driving circuit. In other words, in the embodiments of the present disclosure, the gate driving voltages applied to the gate lines are in an ascending order with an identical incremental voltage from a gate line in a gate line region closest to the gate driving circuit to a gate line in a gate line region farthest from the gate driving circuit.

In the actual implementation, the incremental voltage for each two adjacent gate line regions may be different. The present disclosure is not particularly defined herein.

In an embodiment, determining the first gate line region where the first gate line to which the respective gate driving voltage is to be applied currently is arranged may include: firstly obtaining a row number of the first gate line; and then determining a gate line region corresponding to the row number of the first gate line to be the first gate line region according to a predetermined second correspondence between row numbers of the gate lines and gate line regions.

The step of obtaining the row number of the first gate line may be implemented in various manners, e.g., firstly counting timing signals outputted by a timing controller (T-CON) in the display panel to obtain a counting result; and then determining the row number of the first gate line according to the counting result.

In the actual implementation, the timing signals may be clock (CLK) signals, output enable (OE) signals or touch panel (TP) signals.

For example, prior to count the timing signals outputted by the timing controller in the display panel, the method may further includes: transmitting a reset signal to a counter to zero the counter before each period for applying the gate driving voltages for the display panel, and starting the counter to count the number of the timing signals.

S102: determining a first gate driving voltage corresponding to the first gate line region according to a first correspondence between gate line regions and gate driving voltages.

It is important to preset the first correspondence because each of the gate line regions corresponds to a respective gate driving voltage. In the actual implementation, it is determined a gate line region where gate lines are arranged, and then it is determined a gate driving voltage corresponding to the determined gate line region according to the first correspondence. All of the gate lines within the determined gate line region may be applied with the determined gate driving voltage.

S103: applying the first gate driving voltage to the first gate line.

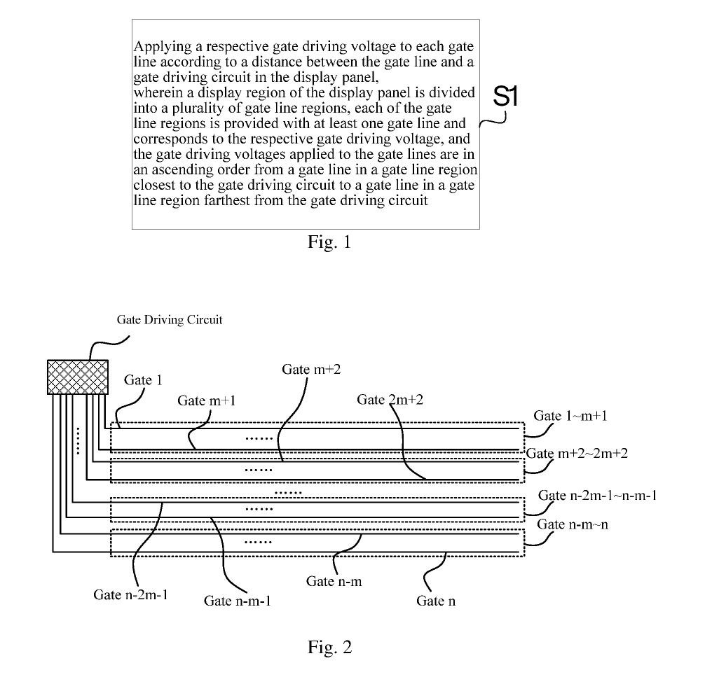

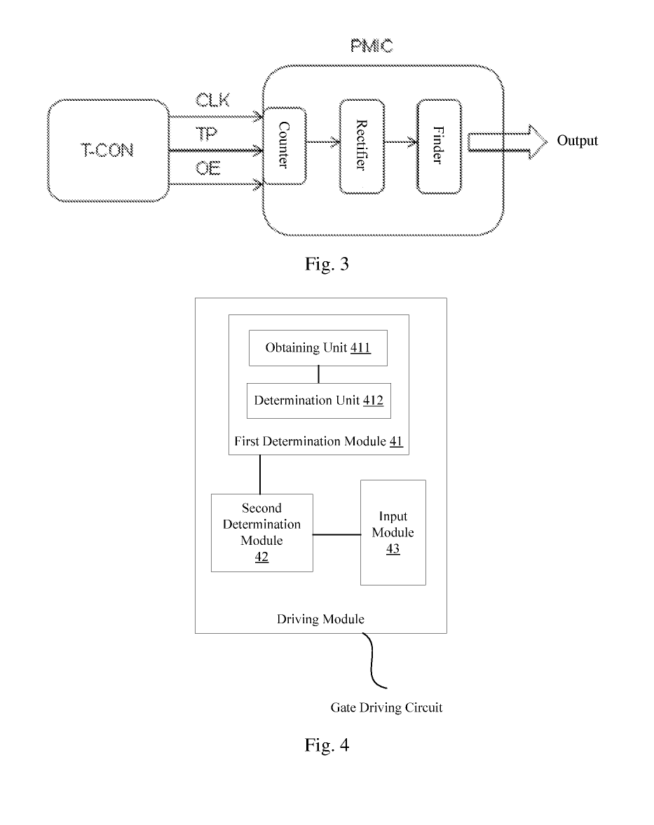

Hereafter, for ease of understanding, the present disclosure will be further explained by referring to FIGS. 2 and 3.

FIG. 2 is a schematic view for driving gate electrodes according to an embodiment of the present disclosure. In FIG. 2, the number of gate lines in each of the gate line regions is identical. As shown in FIG. 2, all of the gate lines Gate are divided into a plurality of gate line regions, including gate lines Gate 1˜m+1, gate lines Gate m+2˜2m+2, . . . , gate lines Gate n−2m−1˜n−m−1, and gate lines Gate n−m˜n. Each of the gate line regions is provided with m+1 gate lines, e.g. the gate lines Gate 1˜m+1 represent the gate line Gate 1 to gate line Gate m+1, i.e. the first gate line region includes m+1 gate lines. Among the gate lines, the gate line Gate 1 is at closest position to the Printed Circuit Board (PCB, i.e. the gate driving circuit), and the gate line Gate n is at a farthest position from the PCB. The panel load at the farthest position from the PCB is large. Therefore, the gate driving voltage for the gate line Gate n is highest, and the gate driving voltage for the gate line Gate 1 is lowest. All of the gate lines Gate 1 to Gate m+1 are in a same gate line region, and thus are applied with an identical gate driving voltage.

In the actual implementation, the value m may be determined according to the actual requirement. The incremental voltage for each of the gate line regions may be flexibly determined, which may be identical or different.

The gate driving voltages for the gate line regions may be stored in a PMIC in advance. The following Table 1 is a driving voltage compensation table.

TABLE 1

| | Gate Line Region | | | | |
|---|---|---|---|---|---|
| | | | | Gate | |
| | Gate | Gate | | n − 2m − | Gate |
| | 1~m + 1 | m + 2~2m + 2 | . . . | 1~n − m − 1 | n − m~n |
| Voltage | V1 | V2 | . . . | Va | Vb |

It can be seen from the above table that, for example, in the case of determining that a row number of the gate line Gate is in the range of Gate m+2˜2m+2, the gate driving voltage V2 may be applied to this gate line Gate; and in the case of determining that a row number of the gate line Gate is in the range of Gate n−2m+1˜n−m−1, the date driving voltage Va may be applied to this gate line Gate. In the above example, the incremental voltage is V2−V1 or Vb−Va. Naturally, in the actual implementation, the incremental voltage V2−V1 may be different from the incremental voltage Vb−Va.

FIG. 3 is a schematic view showing a computation procedure for a PMIC according to an embodiment of the present disclosure, so as to count the timing signals outputted by the T-CON in the display panel. Referring to FIG. 3, the T-CON is provided with the timing signals required by a synchronization processing control panel, and is capable of outputting the control signal to drive the display panel in a direct manner. As shown in FIG. 3, after the T-CON outputs the timing signals such as the CLK signal, the OE signal and the TP signal, it determines which row of gate line is being applied with the gate driving voltage according to an accounting result. At this point, a reset signal may be provided to the counter (i.e. a counting result for a previous frame is zeroed) before the CLK signal, the OE signal, the TP signal and the like for the first row of gate line is outputted, to inform the counter that a further frame starts, and the counting may start again when a following pulse appears.

In the actual implementation, in some cases, the timing signals may be not provided as one signal per row (e.g. a frame may be provided with two timing signals). Thus, a rectifier may be provided to convert data of the counter into row signals (e.g. counting two timing signals as one row signal), and then the row signals are transmitted to a finder to find the gate driving voltage to be applied currently by looking up the table. Finally, the gate driving voltage is applied to the gate lines in the display panel.

In another aspect, the present disclosure provides in some embodiments a gate driving circuit corresponding to the above gate driving method in the display panel. Corresponding to the above gate driving method, the gate driving circuit may include: a driving module configured to apply a respective gate driving voltage to each gate line according to a distance between the gate line and a gate driving circuit in the display panel. Here, a display region of the display panel is divided into a plurality of gate line regions, each of the gate line regions is provided with at least one gate line and corresponds to the respective gate driving voltage, and the gate driving voltages applied to the gate lines are in an ascending order from a gate line in a gate line region closest to the gate driving circuit to a gate line in a gate line region farthest from the gate driving circuit.

FIG. 4 is a schematic view showing components of the gate driving circuit according to an embodiment of the present disclosure. As shown in FIG. 4, the gate driving circuit includes: a first determination module 41 configured to determine a first gate line region where a first gate line to which the respective gate driving voltage is to be applied currently is arranged; a second determination module 42 configured to determine a first gate driving voltage corresponding to the first gate line region according to a first correspondence between gate line regions and gate driving voltages; an input module 43 configured to apply the first gate driving voltage to the first gate line.

The first determination module 41 may includes: an obtaining unit 411 configured to obtain a row number of the first gate line; a determination unit 412 configured to determine a gate line region corresponding to the row number of the first gate line to be the first gate line region according to a second correspondence between row numbers of the gate lines and gate line regions.

In yet another aspect, based on the above gate driving circuit, the present disclosure further provides in some embodiments a display device including the above gate driving circuit. In this display panel, the gate driving circuit may input a gate signal for each of the gate lines by the above gate driving method, which is not further particularly defined herein.

In the embodiments of the present disclosure, a larger gate driving voltage is applied to a gate line farther away from the gate driving circuit and a smaller gate driving voltage is applied to a gate line closer to the gate driving circuit in the display panel. As a result, it may prevent the loss of the gate line signal from occurring in the large scale LCD panel, so as to improve a charging uniformity of the large scale LCD panel.

The above are merely the optional embodiments of the present disclosure. It should be appreciated that, a person skilled in the art may make further modifications and improvements without departing from the principle of the present disclosure, and these modifications and improvements shall also fall within the scope of the present disclosure.

1. A gate driving method for a display panel, comprising:
applying a respective gate driving voltage to each gate line according to a distance between the gate line and a gate driving circuit in the display panel,
wherein a display region of the display panel is divided into a plurality of gate line regions, each of the gate line regions is provided with at least one gate line and corresponds to the respective gate driving voltage, and the gate driving voltages applied to the gate lines are in an ascending order from a gate line in a gate line region closest to the gate driving circuit to a gate line in a gate line region farthest from the gate driving circuit.

2. The method according to claim 1, wherein applying the respective gate driving voltage to each gate line according to the distance between the gate line and the gate driving circuit in the display panel comprises:
determining a first gate line region where a first gate line to which the respective gate driving voltage is to be applied currently is arranged;
determining a first gate driving voltage corresponding to the first gate line region according to a first correspondence between gate line regions and gate driving voltages; and
applying the first gate driving voltage to the first gate line.

3. The method according to claim 2, wherein determining the first gate line region where the first gate line to which the respective gate driving voltage is to be applied currently is arranged comprises:
obtaining a row number of the first gate line; and
determining a gate line region corresponding to the row number of the first gate line to be the first gate line region according to a second correspondence between row numbers of the gate lines and gate line regions.

4. The method according to claim 3, wherein obtaining the row number of the first gate line comprises:
counting timing signals outputted by a timing controller in the display panel to obtain a counting result; and
determining the row number of the first gate line according to the counting result.

5. The method according to claim 4, wherein prior to count the timing signals outputted by the timing controller in the display panel, the method further comprises:
transmitting a reset signal to a counter to zero the counter before each period for applying the gate driving voltages for the display panel, and starting the counter to count the number of the timing signals.

6. The method according to claim 4, wherein the timing signals are clock (CLK) signals, output enable (OE) signals or touch panel (TP) signals.

7. The method according to claim 6, wherein the same number of gate lines are arranged in each gate line region.

8. The method according to claim 6, wherein an incremental voltage for each two adjacent gate line regions is same and greater than 0, and the incremental voltage is obtained by subtracting the gate driving voltage corresponding to one of the two adjacent gate line regions closer to the gate driving circuit from the gate driving voltage corresponding to the other one of the two adjacent gate line regions farther away from the gate driving circuit.

9. A gate driving circuit for a display panel, comprising:
a driving module configured to apply a respective gate driving voltage to each gate line according to a distance between the gate line and a gate driving circuit in the display panel,
wherein a display region of the display panel is divided into a plurality of gate line regions, each of the gate line regions is provided with at least one gate line and corresponds to the respective gate driving voltages, and the gate driving voltages applied to the gate lines are in an ascending order from a gate line in a gate line region closest to the gate driving circuit to a gate line in a gate line region farthest from the gate driving circuit.

10. The gate driving circuit according to claim 9, wherein the driving module comprises:
a first determination module configured to determine a first gate line region where a first gate line to which the respective gate driving voltage is to be applied currently is arranged;
a second determination module configured to determine a first gate driving voltage corresponding to the first gate line region according to a first correspondence between gate line regions and gate driving voltages; and
an input module configured to apply the first gate driving voltage to the first gate line.

11. The gate driving circuit according to claim 10, wherein the first determination module comprises:
an obtaining unit configured to obtain a row number of the first gate line; and
a determination unit configured to determine a gate line region corresponding to the row number of the first gate line to be the first gate line region according to a second correspondence between row numbers of the gate lines and gate line regions.

12. The gate driving circuit according to claim 11, wherein the obtaining unit is further configured to count timing signals outputted by a timing controller in the display panel to obtain a counting result; and determine the row number of the first gate line according to the counting result.

13. The gate driving circuit according to claim 12, wherein before counting the timing signals outputted by the timing controller in the display panel, the obtaining unit is further configured to transmit a reset signal to a counter to zero the counter before each period for applying the gate driving voltages for the display panel, and then start the counter to count the number of the timing signals.

14. The gate driving circuit according to claim 12, wherein the timing signals are clock (CLK) signals, output enable (OE) signals or touch panel (TP) signals.

15. The gate driving circuit according to claim 9, wherein the same number of gate lines are arranged in each gate line region.

16. The gate driving circuit according to claim 9, wherein an incremental voltage for each two adjacent gate line regions is same and greater than 0, and the incremental voltage is obtained by subtracting the gate driving voltage corresponding to one of the two adjacent gate line regions closer to the gate driving circuit from the gate driving voltage corresponding to the other one of the two adjacent gate line regions farther away from the gate driving circuit.

17. A display device comprising the gate driving circuit according to claim 9.

18. The method according to claim 5, wherein the timing signals are clock (CLK) signals, output enable (OE) signals or touch panel (TP) signals.

19. The gate driving circuit according to claim 13, wherein the timing signals are clock (CLK) signals, output enable (OE) signals or touch panel (TP) signals.
